(19) United States
(12) Patent Application Publication
(10) Pub. No.: US 2005/0105005 A1
(43) Pub. Date: May 19, 2005

(54) IMAGE TRANSFERRING DEVICE CONNECTED TO A DISPLAY

(76) Inventors: Yuh-Shyang Wu, Taipei Hsien (TW); Min-Fu Huang, Taipei Hsien (TW); Jyh-Yan Wang, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/707,061

(22) Filed: Nov. 19, 2003

(51) Int. Cl. H04N 3/27

(52) U.S. Cl. 348/706; 348/725

(57) ABSTRACT

An image transferring device connected with a display includes a housing, at least one tuner installed in a connecting port on the housing and capable of being removed for receiving TV signals the tuner having a first demodulator for demodulating the TV signals received by the tuner into AV signals a receiving module installed on the housing for receiving the AV signals, a multiplexer installed in the housing for selectively outputting the AV signals from the tuner or the receiving module, a second demodulator for demodulating the AV signals from the multiplexer, and an output module installed on the housing and electrically connected to the second demodulator, for outputting the AV signals demodulated by the second demodulator to the display.

### BACKGROUND OF INVENTION

1. Field of the Invention

The invention relates to an image transferring device, and more particularly, to an image transferring device connected to a display.

2. Description of the Prior Art

As computers and the Internet progress, a display becomes an indispensable device in a modern information-oriented society. Displays such as plasma display panel (PDP) and liquid crystal display (LCD) are newly developed technologies.

The PDP generates light in the same way as a fluorescent light, by injecting inert gas or mercury gas into a vacuum glass tube and then applying a voltage on it to activate a plasma effect so that ultraviolet (UV) rays are emitted to fluorescent powder applied on the tube, and visible light is generated. The color of the light depends on the fluorescent powder.

The PDP can be regarded as a combination of a few thousand minimized fluorescent lights discharging together, and each discharging area is called a cell. These areas are injected with inert gas such as neon, xenon or helium. The gas-discharges (i.e. plasma), when controlled with a high voltage, emit UV rays in the wavelength of 147 nm so that the fluorescent powder applied in the cell is activated and emits visible light. A color PDP requires fluorescent powder in red, blue, and green. The powder is aligned in different colors or arranged in a mosaic to emit visible rays in red, blue and green. Then the emitted rays are mixed by image processing and a driving circuit to become various colors. Therefore, the PDP is a self-emitting display.

The PDP has better performance, with its compactness and high quality, than conventional televisions; however, it has a higher price due to the complexity of its manufacturing process. As a result, the PDP has not yet replaced conventional televisions. Moreover, the conventional PDP can only receive VGA (video graphics array) signals and DVI (digital video interface) signals. Therefore, it is an object to improve the conventional PDP by increasing the various types of signals it can receive

### SUMMARY OF INVENTION

It is therefore a primary objective of the claimed invention to provide an image transferring device connected to a display.

Briefly, an image transferring device connected with a display includes a housing, at least one tuner installed in a connecting port on the housing and capable of being removed for receiving TV signals the tuner having a first demodulator for demodulating the TV signals received by the tuner into AV signals a receiving module installed on the housing for receiving the AV signals, a multiplexer installed in the housing for selectively outputting the AV signals from the tuner or the receiving module, a second demodulator for demodulating the AV signals from the multiplexer, and an output module installed on the housing and electrically connected to the second demodulator for outputting the AV signals demodulated by the second demodulator to the display.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a block diagram of an image transferring device and a display according to the present invention.

FIG. 2 is an external view of the TV box.

FIG. 3 is an external view of the AV box.

FIG. 4 illustrates the connection between the TV box and the AV box.

### DETAILED DESCRIPTION

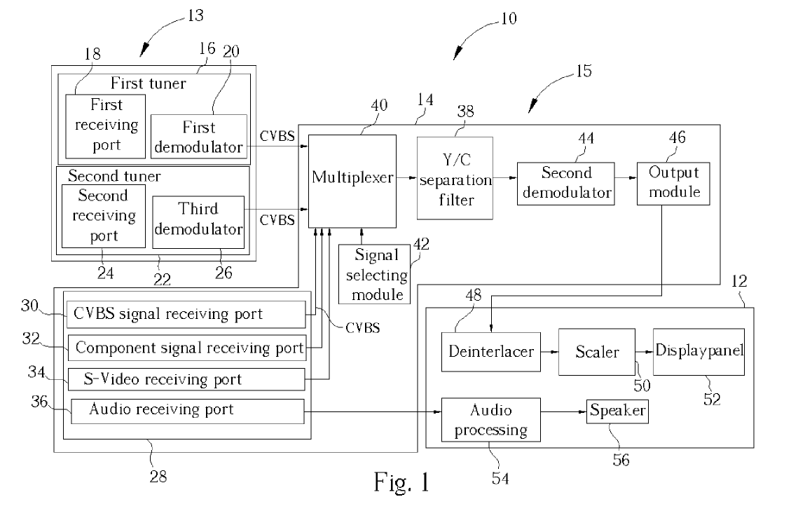

Please refer to FIG. 1 showing a block diagram of an image transferring device 10 and a display 12. The display can be a plasma display or an LCD display. The image transferring device 10 is roughly divided into a TV box 13 and an AV box 15. The TV box 13 has a first tuner 16 and a second tuner 22 for demodulating TV signals into AV signals. The first tuner 16 includes a first receiving port 18 for receiving TV signals and a first demodulator 20 for demodulating the TV signals received by the first receiving port 18 into AV signals in the CVBS (composite video blanking sync) standard. The second tuner 22 includes a second receiving port 24 for receiving TV signals and a third demodulator 26 for demodulating the TV signals received by the second receiving port 24 into AV signals in the CVBS standard. One of the tuners can be for receiving TV signals complying with the PAL (phase alternation by line) standard and the other tuner for receiving TV signals complying with the NTSC (national television system committee) standard, or both of the two tuners can be either NTSC tuners or PAL tuners.

The AV box 15 includes a housing 14 and a receiving module 28 installed in the housing 14 for receiving AV signals. The receiving module 28 includes a CVBS signal receiving port 30 for receiving CVBS signals, a component signal receiving port 32 for receiving component signals, an S-video receiving port 34 for receiving Y/C separation signals, and an audio receiving port 36 for receiving audio signals. The image transferring device 10 further includes a multiplexer 40 installed in the housing 14 and electrically connected to both the TV box 13 and the receiving module 28 for selectively outputting AV signals from the first tuner 16, the second tuner 22 or the receiving module 28; an Y/C separation filter 38 for separating the CVBS signals demodulated by the first demodulator 20 and the third demodulator 26 from luminance signals and chrominance signals received by the CVBS signal receiving port 30, a signal selecting module 42 for selecting AV signals output by the multiplexer 40, a second demodulator 44 for demodulating AV signals from both the multiplexer 40 and the Y/C separation filter 38, and an output module 46 installed on the housing 14 and electrically connected to the second demodulator 44 for outputting AV signals demodulated by the second demodulator 44 to the display 12.

The display 12 has a deinterlacer 48 for converting interlaced scan signals from the output module 46 of the image transferring device 10 into progressive signals. Interlaced scan means scanning odd scan lines and even scan lines separately to display a single picture; in the case of NTSC signals, scanning is operated at 60 times per second to display 30 pictures per second. The purpose of the deinterlacer 48 is to complete two scannings at once, e.g. the first and second scanning at once, the second and third, the third and fourth . . . and so on, to display 60 deinterlaced pictures, which increases the resolution for 30% to 50% than interlaced scanning.

The display 12 further includes both a scaler 50 for converting the resolution from the output module 46 into a resolution that can be displayed by the display 12, e.g. converting the resolution of a TV image signal into the resolution of a computer image signal, and a display panel 52 for displaying the image signal from the scaler 50. The display 12 further includes an audio processing unit 54 for receiving and processing audio signals from an audio receiving port 36 of the image transferring device 10 (e.g. switching from different modes such as MTS mode, stereo mode and mono mode; or controlling the volume) and then transmitting the audio signals to a speaker 56 on the display 12. The speaker 56 converts the signals from the audio processing unit 54 into real sound.

The process of signal transmission is hereby described. The TV box 13, being removable, is installed on the housing of the image transferring device 10. In the case that the TV box 13 is installed, the multiplexer 40 selects whether TV signals from either the first tuner 16 or the second tuner 22 of the TV box 13 is to be output to the Y/C separation filter 38 to separate the luminance signal from the chrominance signal in the CVBS signal demodulated by the either first demodulator 20 or the third demodulator 26. If there is no signal either from the first tuner 16 or the second tuner 22, or if the TV box 13 is removed, the multiplexer 40 will select the signals from the receiving module 28 of the AV box 15 to be output to the Y/C separation filter 38. The first tuner 16 and the second tuner 22 is for receiving two different TV signals, such as PAL and NTSC signals, and the number of the tuners is not limited to two but depends on how many types of signals are required to be output. The first demodulator 20 demodulates the TV signals received by the first receiving port 18 into CVBS signals, and the third demodulator 26 demodulates the TV signals received by the second receiving port 24 into CVBS signals.

The multiplexer 40 receives either CVBS signals the first demodulator 20 or the third demodulator 26, Y/C separation signals received by the S-video receiving port 34, or component signals received by the component signal receiving port 32. The user can select them by a signal selecting module 42. The signal selecting module 42 can be a button set installed on the housing 14 or a remote controller.

The Y/C separation filter 38 is for separating the CVBS signals from the multiplexer 40, which can be either demodulated-CVBS signals sent by the first demodulator 20 or the third demodulator 26, or a luminance signal and chrominance signal received by the CVBS signal receiving port 30. The luminance signal and chrominance signal are in the same format as the Y/C separation signals received by the S-video receiving port 34. The component signal receiving port 32 receives component signals, i.e. YUV separated signals. The component signals are similar in nature to the Y/C signals; thus the Y/C separation signals received by the S-video receiving port 34 and the component signals received by the component signal receiving port 32 can be processed by the Y/C separation filter 38 when passing through it.

Continuously, the signals output by the Y/C separation filter 38 are transmitted to the second demodulator 44 to be demodulated and transmitted to the output module 46. The demodulated signals can be YUV signals or RGB signals. Then the output module 46 outputs the demodulated signals to the display 12.

If the signals output by the output module 46 are interlaced scanning signals, such as TV signals received by the TV box 13, the deinterlacer 48 of the display 12 deinterlaces the signals to comply with the display 12, which is being used as a monitor. And if the signals are not interlaced scanning signals, then the deinterlacing process can be omitted, and the signals are output to the scaler 50 for further processing. The scaler 50 converts the resolution of the signals from the output module 46 into a resolution capable of being displayed by the display 12, e.g. converting TV signals resolution into computer signal resolution. Then the signals converted by the scaler 50 is displayed by the panel 52. The audio signals received by the audio receiving port 36 are processed by the audio processing unit 54 and then played by the speaker 56.

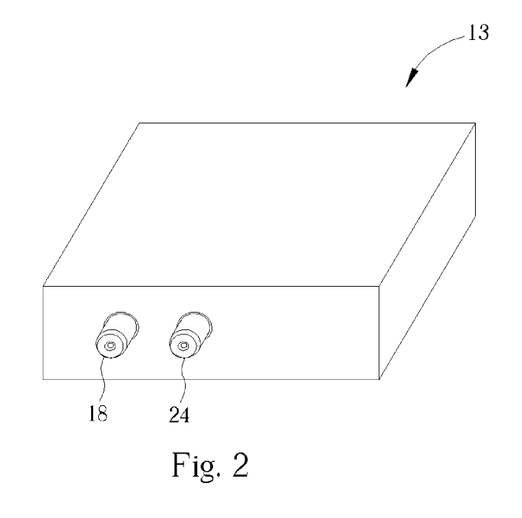

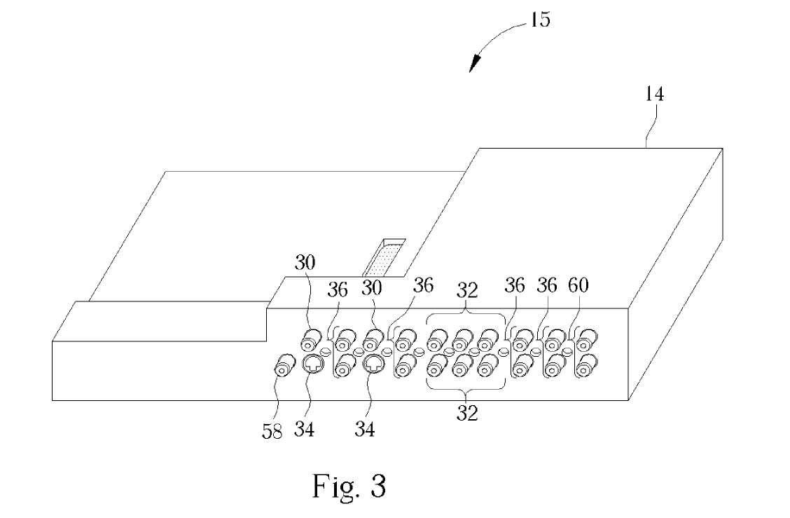

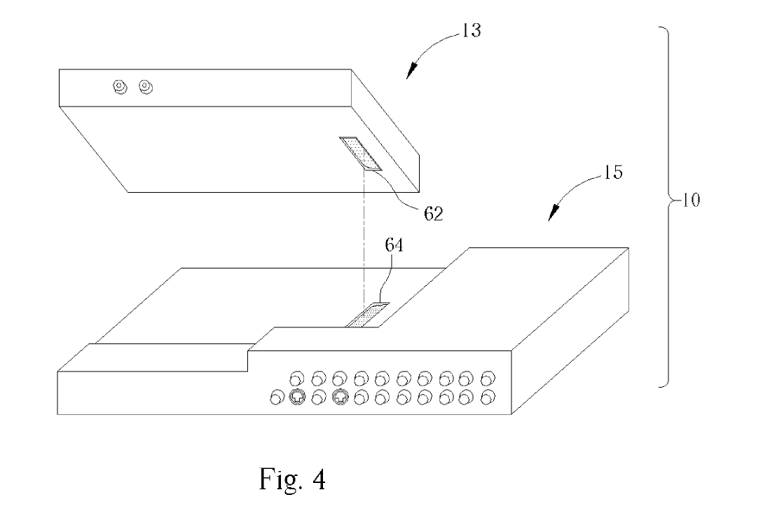

Please refer to FIG. 2 showing an external view of the TV box 13. The first receiving port 18 and the second receiving port 24 can be installed on the housing of the TV box 13, both of which are to be connected to TV signal lines. Please refer to FIG. 3 showing an external view of the AV box 15. The receiving ports of the receiving module 28 can be installed on the housing 14. As shown in the figure, the component signal receiving port 32 has two sets of YUV signal terminals, each set including three terminals. The CVBS signal receiving port 30 and the S-video receiving port 34 have respectively two sets of signal terminals. On the audio side, the AV box 15 has an audio receiving port 36, which has four sets of signal terminals, a woofer terminal 58 for receiving signals from a woofer, and an audio output port 60 of one set of terminals for outputting audio signals. Please refer to FIG. 4 showing the connection between the TV box 13 and the AV box 15. The TV box 13 has a first connecting port 62 and the AV box 15 has a second connecting port 64, which can connect to each other wherein signal transmission depends on this connection. The image transferring device 10 can be installed on the display 12, connected to the display 12 wired or wirelessly, or installed within the display 12.

In contrast to the prior art, the image transferring device according to the present invention can not only display VGA and DVI signals as in the prior art but also other signals so that the PDP or the LCD is no longer limited to being used as a monitor of a computer but can be used to display TV signals. The present invention improves the performance of conventional PDP and LCD displays.

Those skilled in the art will readily observe that numerous modifications and alterations of the device may be made while retaining the teachings of the invention. Accordingly, the above disclosure should be construed as limited only by the metes and bounds of the appended claims.

1. An image transferring device connected with a display comprising:
a housing;
at least one tuner installed in a connecting port on the housing and capable of being removed for receiving TV signals, the tuner comprising a first demodulator for demodulating the TV signals received by the tuner into AV signals;
a receiving module installed on the housing for receiving the AV signals;
a multiplexer installed in the housing for selectively outputting the AV signals from the tuner or the receiving module;
a second demodulator for demodulating the AV signals from the multiplexer; and
an output module installed on the housing and electrically connected to the second demodulator for outputting the AV signals demodulated by the second demodulator to the display.

2. The image transferring device of claim 1 wherein the tuner can receive TV signals complying with the PAL (phase alternation by line) standard.

3. The image transferring device of claim 1 wherein the tuner can receive TV signals complying with the NTSC (national television system committee) standard.

4. The image transferring device of claim 1 wherein the receiving module comprises a CVBS signal receiving port for receiving CVBS signals.

5. The image transferring device of claim 4 further comprising an Y/C separation filter for separating luminance signals from chrominance signals in the CVBS signals received by the CVBS signal receiving port.

6. The image transferring device of claim 1 wherein the receiving port comprises a component signal receiving port for receiving component signals.

7. The image transferring device of claim 1 wherein the receiving module comprises an S-video receiving port for receiving Y/C separation signals.

8. The image transferring device of claim 1 further comprises a signal selecting module for selecting the AV signals for the multiplexer to output.

9. The image transferring device of claim 1 wherein the output module can output YUV signals to the display.

10. The image transferring device of claim 1 wherein the output module can output RGB signals to the display.

11. The image transferring device of claim 1 being removable and connected to the display.

12. The image transferring device of claim 1 wherein the first demodulator is for demodulating radio TV signals received by the tuner into CVBS signals, and the image transferring device further comprises an Y/C separation filter to separate the CVBS signals into the luminance signals and the chrominance signals.

13. The image transferring device of claim 1 further comprising two tuners respectively for receiving PAL signals and NTSC signals.

14. The image transferring device of claim 1 further comprising two tuners both for receiving PAL signals or NTSC signals.

15. The image transferring device of claim 1 wherein the display is a plasma display panel (PDP).

16. The image transferring device of claim 1 wherein the display is a liquid crystal display (LCD).
